(19) United States
(12) Patent Application Publication
(10) Pub. No.: US 2005/0133319 A1
(43) Pub. Date: Jun. 23, 2005

(54) Shock absorber for a motor vehicle

(76) Inventor: Ralf Wilhelm, Oberreichenbach (DE)

Correspondence Address: KLAUS J. BACH, 4407 TWIN OAKS DRIVE, MURRYSVILLE, PA, 15668, US

(21) Appl. No.: 11/014,470

(22) Filed: Dec. 16, 2004

(30) Foreign Application Priority Data
Dec. 20, 2003 (DE) 103 60 140.6

(51) Int. Cl. F16F 9/50

(52) U.S. Cl. 188/281

(57) ABSTRACT

In a shock absorber for a motor vehicle for damping the relative movement between a vehicle wheel and a vehicle body, comprising a damper housing filled with an operating medium and a piston rod with a piston disposed in the damper housing so as to divide the interior of the damper housing into two operating chambers and forming a first damper element, a second damper element is disposed in the piston rod and is in communication with the two operating chambers by way of bypass bores extending through the piston rod.

### BACKGROUND OF THE INVENTION

The invention relates to a shock absorber for a motor vehicle for damping the relative movements between a vehicle wheel and a vehicle body, compressing a first damper element with a damper housing which is filled with an operating medium and in which a piston is disposed which divides the interior volume of the damper housing into two operating chambers and is connected to a piston rod for actuating the piston in the housing.

EP 1 152 166 A1 discloses a shock absorber with an amplitude-dependent dampening action. It includes a first damper element which has a piston arranged in a damper housing. A second damper element is provided in the shock absorber for damping movements with small amplitudes. To this end, an additional space is provided, which is arranged hydraulically parallel to the first element and which is divided into two subspaces by a membrane or an axially movable solid disc. The piston divides the damper housing into two operating chambers each of which is in communication with one side of the two subspaces of the second damper element. The additional space divided by the membrane or the solid disc into the two subspaces acts as a balancing space during small shock absorber movements for smaller damping actions during low amplitude oscillations. The damping action of the first damper element becomes effective only with larger piston movements, that is, after the damping action of the second damper element is exhausted. The second damper element is arranged either between the piston rod and the operating piston or at the side of the operating piston remote from the piston rod. In each case, the possible travel distance of the piston is reduced by the axial length of the second damper element.

It is the object of the present invention to provide a shock absorber with an amplitude-dependent damping action with only little reduction in the piston stroke length.

### SUMMARY OF THE INVENTION

In a shock absorber for a motor vehicle for damping the relative movement between a vehicle wheel and a vehicle body, comprising a damper housing filled with an operating medium and a piston rod with a piston disposed in the damper housing so as to divide the interior of the damper housing into two operating chambers and forming a first damper element, a second damper element is disposed in the piston rod and is in communication with the two operating chambers by way of bypass bores extending through the piston rod.

The piston rod includes a longitudinal bore which provides for an installation space for the second damper element without requiring additional construction space. The hydraulic communication between the second damper element and the operating chambers of the first damper element is established in a simple manner by longitudinal and transverse bores provided in the piston rod.

In a particular embodiment of the invention, the piston rod comprises a first piston rod section and a second piston rod section. The separation of the piston rod into two sections facilitates the establishment of an installation space in the piston rod for the second damping element.

In another embodiment of the invention, the second piston rod section includes a blind end bore in which the second damper element is arranged. In this way, the outer diameter of the first piston rod section does not depend on the diameter of the blind end bore receiving the second damper element in the second piston rod section. As a result, operating pistons of normal shock absorbers can be used in the manufacture of the shock absorber.

In a particular embodiment of the invention, the first piston rod section and the second piston rod section are capable of being pre-assembled. A very accurately prepared press-fit provides for an optimal centering of the first piston rod section to the second piston rod section. The provision of a press fit is advantageous for an automatic manufacturing procedure.

Preferably, the first piston rod section and the second piston rod section are welded together. The welding of the two piston rod sections provides for an inexpensive high strength connection.

The second damper element includes a slide member disposed in the longitudinal bore of the second piston rod section. The slide member divides the longitudinal bore by means of an enlarged diameter guide structure into two chambers which are in communication with the respective operating chambers of the first damper element. The slide member is simple and can easily be manufactured on a lathe or by injection molding from a metallic or plastic material. The slide member preferably includes sealing areas by way of which the bypass bores can be closed. The end faces of the slide member are preferably used as the sealing areas. If the slide member is biased toward either end area of the longitudinal bore, the bypass bore is blocked by the sealing area. As a result, the flow of operating medium through the longitudinal bore is blocked. As long as the operating medium flow through the longitudinal bore is blocked, damping is provided only by the first damper element. In this way, a two-stage damping structure is obtained.

Preferably, the sealing areas on the slide member are formed by cone-shaped projections which extend into the bypass passages at opposite ends of the longitudinal bore for centering the slide member. The centering of the slide member in the bypass passages prevents cogging of the slide member in the longitudinal bore.

In order to provide for good sealing the sealing surfaces of the slide member are provided with layers of an elastomer material. The sealing of the bypass bores by means of an elastic sealing material of an elastomer or a similar elastic material effectively reduces any leakage of the operating medium when the bypass bore is closed. The elastomer material may be attached by cementing form-locking or vulcanization onto the seal surfaces of the slide member.

In a particular embodiment, the slide member includes two control edges by which the bypass bores can be closed. Upon axial movement of the slide member, a control edge moves past a respective bypass bore of the second piston rod section whereby the flow of the operating medium is reduced or stopped. The slide member can be manufactured inexpensively as a turned piece.

Preferably, the slide member has a first and a second guide diameter. With the two guide diameters, two control edges are provided in a simple manner for closing the bypass bores in the second piston rod section when the wheel spring travel amplitudes are large in either direction.

In a particular embodiment bores for an operating fluid flow are provided in a cylinder ring of the second guide diameter area, through which operating fluid displaced during small amplitude movements of the wheel can flow. With the bores, operating fluid admission and its discharge by way of the bypass bores in the second piston rod section in the center of the slide member is facilitated. In this way, a small distance between the bypass bore and a piston of the first damper element is ensured so that the reduction of the damper travel distance of the shock-absorber by the provision of the second damper element is small.

Preferably, in accordance with the invention, the slide member is held in a neutral rest position by opposing springs arranged at opposite ends of the slide member. The springs are preferably coil or disc springs. The spring elasticity is so selected that, with short shocks, that is small amplitudes of the operating piston, the bypass bores are held open but with larger amplitudes the bypass bores are closed. By way of the spring elasticity, the degree of damping in dependence on the amplitude is adjustable. The use of springs with different elasticities provides for different behavior in connection with a stress or compression load (downward or upward movement of the wheel).

Advantageously, the springs have progressive spring characteristics. For example, coil springs with different pitch may be used so as to provide for a progressive spring characteristic, that is, that the spring stiffness increases with a compression of the spring. With the use of such progressive characteristic springs, the transition from a soft to a harder damping characteristic and vice versa can be influenced.

The springs may also have a temperature-dependent elasticity. Then the transition between a soft and hard spring characteristic and vice versa can also be influenced in a temperature-dependent manner. To this end, the springs may consist of a bi-metal or a shape memory material. Also, a combination of springs that is an arrangement of springs disposed in series or in parallel including springs with temperature-dependent and springs with non-temperature dependent characteristics may be provided to achieve a desirable switching behavior.

The invention will become more readily apparent from the following description of particular embodiments thereof on the basis of the accompanying drawings.

### BRIEF DESCRIPTION OF THE DRAWINGS

FIG. 1 shows a shock absorber structure according to the invention, and

FIG. 2 shows another embodiment of the shock absorber arrangement according to the invention.

### DESCRIPTION OF THE PREFERRED EMBODIMENTS

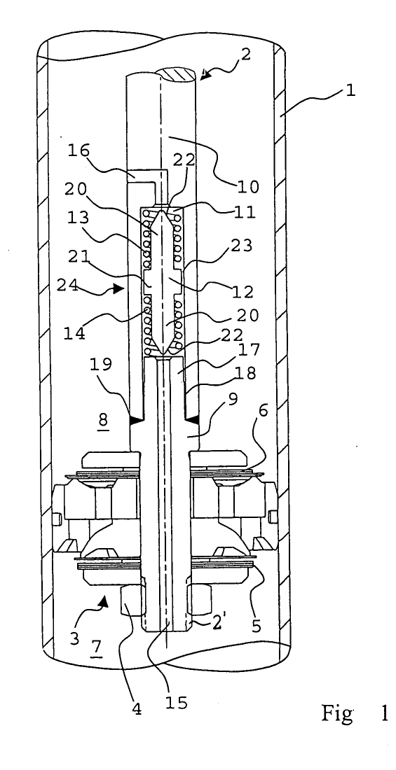

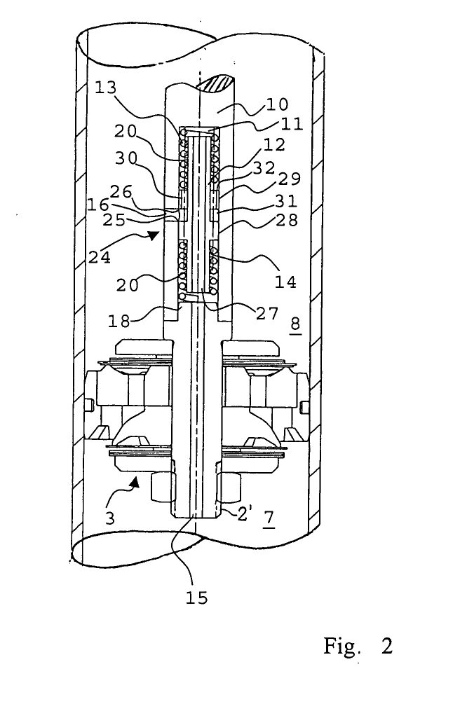

In the description, identical components are designated by the same reference numerals in FIG. 1 and in FIG. 2.

FIG. 1 shows the essential components of a shock absorber, that is, of a single tube shock absorber, which is connected between a vehicle body and a wheel suspension carrying a vehicle wheel. In the same way, a double tube shock absorber may be used. For mounting the shock absorber, mounting eyelets are provided on a shock absorber housing 1 and a piston rod 2, which are however not shown. By up and down movement of the wheel, the piston rod 2 is moved relative to the shock absorber housing 1.

In the shock absorber housing 1, a piston 3 is arranged mounted on the piston rod 2. The piston 3 divides the inner volume of the shock absorber housing 1, which is filled with an operating medium, into a first operating chamber 7 and a second operating chamber 8.

The piston 3 is provided with two plate valves 5, 6 and flow passages which together determine the form of the damping characteristic line. If, for example, the piston rod 2 moves out of the shock absorber housing 1, the operating medium, which is preferably a hydraulic oil, flows from the second operating chamber 8 to the first operating chamber 7 by way of bores provided in the piston 3 and the plate valve 5. When the piston 3 moves into the shock absorber housing 1, the flow of the hydraulic oil is reversed and is damped by the plate valve 6. By different design features of the plate valves 5, 6, different characteristic damping lines can be provided for the inward- and outward movement of the piston rod 2. The piston rod 2 is provided at its free end with a thread 2′ onto which a nut 4 is threaded for mounting the piston 3 and the plate valve 5, 6 on the piston rod 2.

The piston rod 2 is a two part component comprising a first piston rod section 9 and a second piston rod section 10. The second piston rod section 10 is provided with an axial blind end bore 11 in which a second damper structure 24 is disposed. The second damper structure 24 comprises a slide member 12 and springs 13, 14 arranged at opposite ends of the slide member 12 and engaging the slide member 12 to retain it resiliently in a neutral position. The first piston rod section 9 includes a bypass bore 15 extending axially through the first piston rod section and the second piston rod section 10 includes a bypass bore 16 in the form of a partially axial and transverse bore. The two piston rod sections 9, 10 are joined by a press fit and by welding so that the slide member 12 and the springs 13, 14 are enclosed in the blind end bore 11 which is in communication with the operating chambers 7 and 8 by way of the bypass bores 15 and 16.

Preferably, the blind end bore 11 extends into the second piston rod section 10 to such an extent that, for the jointure, a projection 17 of the first piston rod section 9 is insertable into the blind end bore 11 and tightly received therein so that it is not again pushed out by the springs 13, 14. As a result, the springs 13, 14 and the slide member 12 are captured in the blind end bore 11 and subsequent assembly procedures are simplified. By the press fit 18, the first and second piston rod sections 9, 10 are also accurately positioned relative to each other. By a subsequently applied weld joint 19, a firm connection between the piston rod sections 9, 10 is established.

The slide member 12 has areas with two areas of smaller diameter 20 on which the springs 13, 14 are guided and an area 21 of a larger diameter for guiding the slide member 12 in the blind end bore 11. Some play is provided between the blind end bore 11 and the slide member guide area 21 such that an annular gap 23 remains through which a particular flow of hydraulic oil can occur. The flow cross-section of the annular gap 23 is larger than the flow cross-section of the bypass bores 15 and 16 so that the flow volume is controlled by the bypass bores. In a particular embodiment of the invention, the diameter of the guide area 21 of the slide member 20 is large enough that the slide member 20 is guided in the blind end bore 11 with little play. In order to provide passages for the hydraulic fluid past the guide area 21 of the slide member 12, the guide area 21 is provided with axial grooves or flat, reduced-diameter areas.

At its axial opposite ends, the slide member 12 is provided with cone-shaped seal areas 22. Upon sufficient displacement of the slide member 12 out of its neutral position, the seal areas 22 close the bypass bores 15, 16. The cone-shaped seal areas 22 provide furthermore for additional centering of the slide member 12 in the bypass bores 15, 16.

In order to reduce costs, it is also possible to use planar seal surfaces 22. In order to prevent cogging of the slide member 12, sufficient guidance must then be provided for the slide member 12 by the guides structure 11 and the springs 13, 14.

With relatively small relative movements between the piston 3 and the shock absorber housing 1, that is, with small amplitudes of the movement of the piston 3 in the shock absorber housing 1, hydraulic oil can flow from the first to the second operating chamber 7, 8, and vice versa, by way of the bypass bores 15, 16, the blind end bore 11 and the annular gap 23. In this case, a relatively small damping is obtained which is determined by the size of the bypass bores 15, 16 and the annular gap 23. With increasing amplitude of the movement of the piston rod 2 in the housing 1, the slide member 12 is displaced as a result of the pressure difference across the annular gap 23. With sufficiently large amplitudes and wheel spring movement speeds, the pressure difference causes the slide member 12 to move toward one end position in the blind end bore 11, whereby one of the bypass bores 15, 16 is closed. As a result, the flow of hydraulic oil through the bypass bores 15, 16 is interrupted so that the hydraulic oil can flow from one operating chamber to the other (7, 8) only by way of the plate valves 5, 6 of the piston 3. Damping is now provided exclusively by the plate valves 5, o and is now preferably substantially stronger. As a result, with the shock absorber according to the invention, a two-stage damper characteristic line can be provided. By the stiffness of the springs 13, 14, variations in the travel distance of the slide member 20 and variations in the flow cross-sections for the hydraulic oil, the switch-over point from soft to hard damping characteristics and the behavior in the transition area is adjustable depending on the amplitudes and the piston speed.

FIG. 2 shows another embodiment of a shock absorber according to the invention. Again, the slide member 12 is engaged between the spring 13, 14, which are guided by the smaller diameter end portions 20 of the slide member 12 and are each supported on the larger diameter first and second guide rims 28, 29 respectively. Between the guide rims 28, 29, a circumferential groove 31 is provided. The guide rims 28, 29 at opposite ends of the groove 31 form control edges 25, 26. In the guide rim 29, axial bores 30 are provided for the passage of the hydraulic oil. There are preferably four bores (30, 32) circumferentially displaced by 90°. The diameters of the guide rims 28, 29 are preferably so selected that little clearance remains between the blind end bore 11 and the circumferential walls of the guide rims 28, 29 in order to limit the hydraulic fluid leakage past the guide rims 28, 29. The slide member 12 includes an axial center bore 27 extending fully through the slide member 12.

With small movements of the piston 3 relative to the shock absorber housing 1, the hydraulic oil flows from the first to the second operating chamber 7, 8 and vice-versa by way of the bypass bore 15 into the blind end bore 11, by way of the center bore 27 to the axial bores 30 and via the groove 31 to the radial bypass bore 16. Under these conditions, there is a relatively small damping effect provided, which is controlled by the bypass bores 15, 16 and the axial bores 30.

With larger amplitudes of movement of the piston 3, the slide member 12 is displaced because of the pressure difference generated in the operating chambers 7, 8. The slide member 12 moves axially within the blind end bore 11 so that, depending on the direction of movement of the piston 3, the control edge 25 or the control edge 26 moves across the bypass bore 16. As soon as the bypass bore 16 is covered by one of the guide rims 28, 29, the bypass bore 16 is closed. The closing of the bypass bore 16 by the control edges or, respectively, the guide rims 28, 29 does not occur suddenly so that the transition between the characteristic damping lines is smooth.

The embodiment as shown in FIG. 2 has the advantage that the bypass passage 16 is not arranged at the top end of the blind end bore 11 but extends from the center area of the slide member 12 to the second operating chamber 8. With the arrangement of the damper element 24 as shown, the maximum shock absorber damping distance is only slightly reduced. The reduction of the travel distance is further minimized by a short press-fit 18, whereby the bypass bore 16 is moved closer to the piston 3.

In a modified embodiment, different damping behaviors can be achieved by different stiffnesses of the spring 13, 14. By an appropriate tuning of the springs 13, 14 possibly with different spring characteristics for the front and the rear axles of a vehicle, optimal handling can be achieved.

By the user of springs with progressive or degressive pitch further tuning capabilities are provided.

1. A shock absorber for a motor vehicle for damping the relative movement between a vehicle wheel and a vehicle body, comprising: a damper housing (1) filled with an operating medium, a piston (3) disposed in said damper housing (1) and dividing the damper housing interior into two operating chambers (7, 8), a piston rod (2) extending into the damper housing (1) and being connected to the piston (3), which forms in the damper housing (1) a first damper element, and a second damper element (24) disposed in the piston rod (2) and being in communication with the two operating chambers (7, 8) by way of bypass bores (15, 16) extending in the piston rod (2).

2. A shock absorber according to claim 1, wherein the piston rod (2) comprises a first piston rod section (9) and a second piston rod section (10) joined with the first piston rod section (3).

3. A shock absorber according to claim 2, wherein the second piston rod section (10) includes a blind end bore (11) in which the second damper element (24) is disposed.

4. A shock absorber according to claim 2, wherein the first piston rod section (9) and the second piston rod section (10) are preassembled by a press fit connection (18).

5. A shock absorber according to claim 2, wherein the first and the second piston rod sections (9, 10) are welded together.

6. A shock absorber according to claim 1, wherein the second damper element (24) includes a slide member (12).

7. A shock absorber according to claim 6, wherein the slide member (12) includes seal areas (22) for blocking the bypass bores (15, 16).

8. A shock absorber according to claim 7, wherein the seal areas (22) the cone-shaped ends (22) of the slide member (12) and the bypass bores (15, 16) are arranged adjacent the opposite ends of the slide member (12), the cone-shaped ends (22) of the slide member (12) extending into the bypass bores (15, 16) for centering the slide member (12) in the bypass bore (15, 16).

9. A shock absorber according to claim 7, wherein the seal areas (22) of the slide member (12) are provided with layers of an elastomer material for improving the sealing quality of the seal areas.

10. A shock absorber according to claim 6, wherein one of said bypass bores (16) extends radially from said blind end bore (11) and the slide member 12 includes a guide structure with control edges for closing and opening the bypass bore (16).

11. A shock absorber according to claim 10, wherein the guide structure of the slide member 12 includes first and second axially spaced guide rims (28, 29).

12. A shock absorber according to claim 10, wherein the slide member (12) includes an axial center bore (27) and one of the guide rims (29) includes axial bores (30, 32) for accommodating operating medium flow therethrough.

13. A shock absorber according to claim 6, wherein springs (13, 14) are arranged at opposite ends of the slide member (12) resiliently engaging the slide member 12 therebetween.

14. A shock absorber according to claim 13, wherein the springs (13, 14) disposed at opposite ends of the slide member (12) have different spring characteristics.

15. A shock absorber according to claim 13, wherein said springs (13, 14) have progressive spring characteristics.

16. A shock absorber according to claim 13, wherein said springs (13, 14) have temperature dependent spring characteristics.
